(19) United States
(12) Patent Application Publication
(10) Pub. No.: US 2026/0233156 A1
(43) Pub. Date: Aug. 13, 2026

(54) MEMBRANE CAPTURE OF CO2 FROM REFINERY EMISSIONS

(71) Applicant: Chevron U.S.A. Inc., San Ramon, CA (US)

(72) Inventors: Daniel CHINN, Danville, CA (US); Nitesh BHUWANIA, Richmond, CA (US); Zunqing HE, San Rafael, CA (US)

(21) Appl. No.: 19/637,545

(22) Filed: Apr. 2, 2026

Related U.S. Application Data
(63) Continuation-in-part of application No. 17/493,927, filed on Oct. 5, 2021, now Pat. No. 12,594,523.
(60) Provisional application No. 63/087,863, filed on Oct. 5, 2020.

(51) Int. Cl. B01D 53/22; B01D 53/00; B01J 20/28; F25J 3/06

(52) U.S. Cl. CPC B01D 53/226; B01D 53/002; B01D 53/225; B01D 53/229; B01J 20/28038; F25J 3/062; F25J 3/067; B01D 2053/224; F25J 2205/80

(57) ABSTRACT

The present invention is directed to a method of capturing CO2 from, for example, a FCC regenerator or other CO2 production, using select membranes. In some embodiments, a flowrate of a counter-current air sweep is adjusted to maintain about the same or higher percentage of excess oxygen as, for example, an FCC regenerator. In some embodiments, a portion of combustion air for the FCC regenerator may be replaced by C02-enriched, oxygen-depleted air sweep from a membrane operating with counter-current air sweep.

### CROSS-REFERENCE TO RELATED APPLICATIONS

This application is a continuation-in-part of U.S. Ser. No. 17/493,927 filed Oct. 5, 2021 which application claims priority to U.S. provisional application 63/087,863 filed Oct. 5, 2020, both of which are incorporated herein by reference.

### FIELD OF THE INVENTION

This invention relates to the reduction of CO2 emissions from a Fluid Catalytic Cracker (FCC) regenerator via membrane capture of CO2.

### BACKGROUND OF THE INVENTION

One of the biggest point-sources of CO2 emissions in a refinery is the FCC (Fluid Catalytic Cracker) regenerator offgas. In the FCC regenerator, spent catalyst is regenerated by burning the coke with air at high temperature. An FCC with 390 tonne/day coke will yield emissions of 0.46 million tonnes/year (MMTPA) of CO2 when burned with air based on 20% excess 02. The flue gas from a FCC regenerator is hot, dilute in CO2, and at low-pressure which renders separation and recovery of the CO2 challenging. One known-art process for capturing CO2 is based on amine absorption using solvents such as Fluor Econamine FG, 30 wt. % monoethanolamine (MEA), and Mitsubishisi Heavy Industry's KS-1. The flue gas is first cooled to a suitable temperature such as 50 C, and then compressed in a blower to overcome the pressure drop from the downstream equipment. The gas then goes through an amine plant, which comprises an amine absorber (not shown) for removing the CO2 and an amine regenerator (not shown) for recovering the CO2 from the solvent. The amine plant reduces the direct CO2 emissions from the FCC unit down to 0.08 MMTPA, however, since power and steam are needed to circulate and regenerate the solvent, indirect emissions of 0.10 MMTPA are incurred. The net avoided CO2 emissions are thus 0.26 MMTPA. One of the disadvantages of the amine process is that the process equipment and footprint are significant, which often translate to high capital costs. High steam consumption leads to high operating costs and high indirect CO2 emissions from the steam boilers.

A method for capturing CO2 without high steam consumption and lower indirect CO2 emissions is therefore desired.

### SUMMARY OF THE INVENTION

Herein is disclosed a method for CO2 capture from refinery exhaust emissions or flue gas using crossflow and sweep-based membranes in series.

A further embodiment is a method of lowering the input of energy required to capture CO2 from an FCC regenerator using select membranes.

### BRIEF DESCRIPTION OF THE DRAWINGS

FIG. 1 is a diagram of FCC emissions.

FIG. 2 is a diagram of a process for capturing CO2 known in the art based on amine absorption.

FIG. 3 and FIG. 4 show how a membrane process may be integrated with a FCC regenerator.

FIG. 5 is another embodiment in the process where a lower sweep gas flowrate is used while a higher amount of fresh air is used for the FCC regenerator to achieve 20% excess 02.

FIG. 6 is a diagram of an alternative embodiment of the membrane configuration wherein the polishing membrane is eliminated.

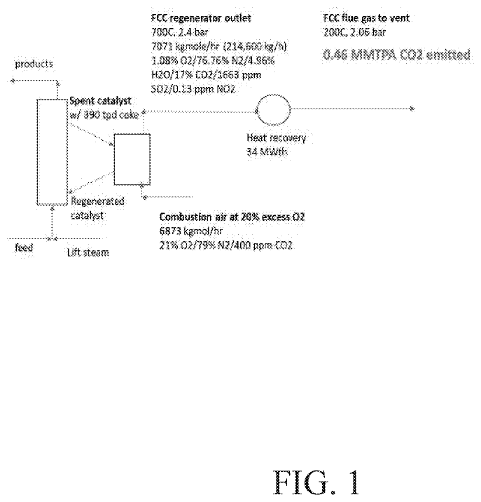

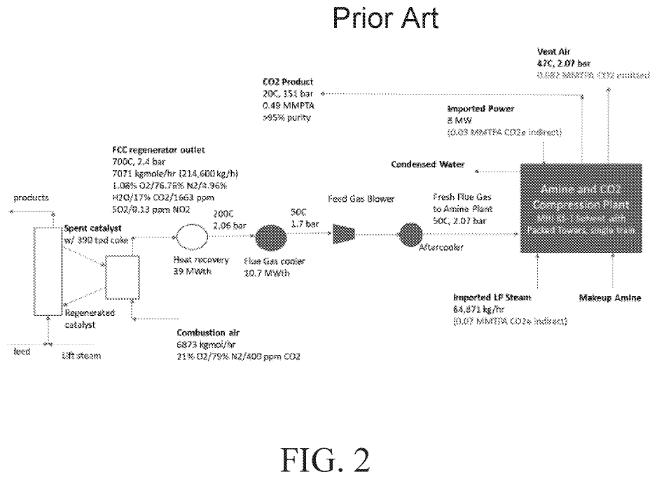

### DETAILED DESCRIPTION OF THE INVENTION

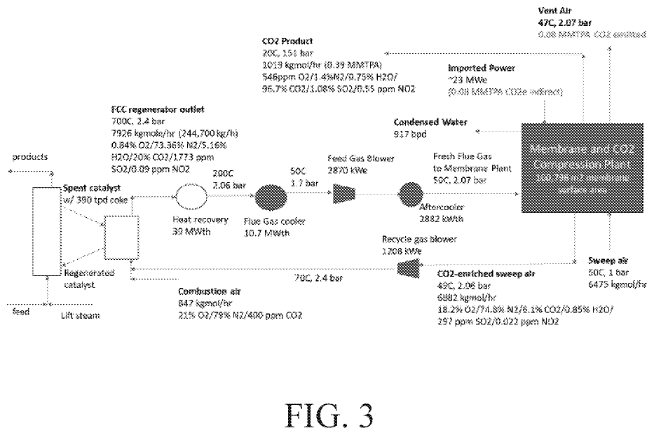

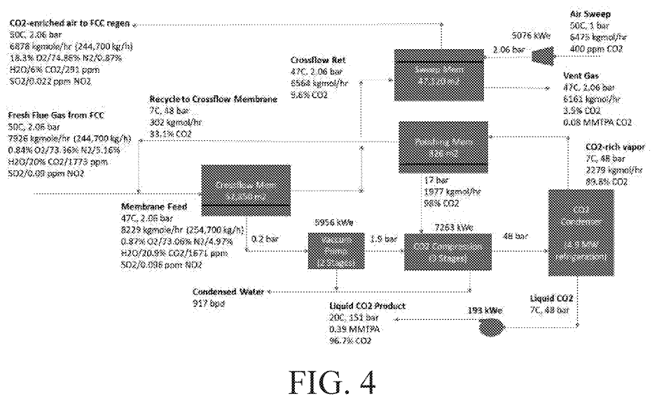

Herein is a further embodiment for CO2 capture from a FCC wherein a membrane process may be integrated with a FCC regenerator (FIG. 3 & FIG. 4).

Embodiments of the invention as described herein pertain to refinery-based combustion systems and flue gas treatment systems which incorporate sweep-based membrane separation units to control carbon dioxide emissions from combustion processes and streams.

An embodiment of the invention is a method for capturing CO2 produced from a FCC regenerator flue gas comprising, (1) cooling and compression of the flue gas to overcome the pressure drop in equipment downstream of the FCC regenerator; (2) operating a crossflow membrane at vacuum permeate pressure to remove the bulk of the CO2, followed by a membrane which operates with a counter-current air sweep on the permeate side to further reduce the CO2 amount; (3) two stage compression of permeate from the crossflow membrane using vacuum pumps and then in 3 stages of compression to 48 bar; (4) liquefying the CO2 using a CO2 liquefaction unit that liquefies CO2 out the bottom and produces a CO2-rich vapor which is sent to a high-pressure polishing membrane; (5) recycling the permeate of the polishing membrane to the liquefaction unit feed while the retentate is recycled to the crossflow membrane feed.

Another embodiment of the invention (as seen in FIG. 3) is cooling and compression of the flue gas to overcome the pressure drop in equipment downstream of the FCC regenerator. The difference with the amine process is twofold: (1) there is no steam import required, and (2) a portion of the combustion air for the FCC is replaced by a CO2-enriched, oxygen-depleted air sweep. The air sweep flowrate is adjusted to ensure the same % excess oxygen as the uncontrolled FCC. The direct emissions of the membrane process is 0.08 MMTPA. Indirect emissions from 23 MW of power import is 0.08 MMTPA, which results in an avoidance of 0.46-0.08-0.08=0.30 MMTPA, which is 15% better than the amine case. FIG. 4 shows more detail of how to arrange the membrane flowsheet.

Previous efforts to remove CO2 from a flue gas comprise removal in two stages in series and may be based exclusively on spiral-wound membranes which have inherently less packing efficiency and thus will necessarily take up more space in a refinery operation compared to using hollow-fiber membranes. Therefore, an embodiment of the invention is the use of a crossflow membrane which operates at vacuum permeate pressure, 0.1 to 0.2 bar, or about 0, e.g., 0.0001 up to about 0.3 bar, or up to 0.5 bar, to remove the bulk of the CO2, followed by a hollow-fiber module which operates with a counter-current air sweep on the permeate side to further reduce the CO2 amount. The permeate from the crossflow membrane is compressed in 2 stages using vacuum pumps and then in 3 stages of compression to 48 bar. A CO2 liquefaction unit operating at 7 C liquefies CO2 out the bottoms and produces a CO2-rich vapor which is sent to a high-pressure polishing membrane. The permeate of the polishing membrane is recycled to the liquefaction unit feed while the retentate is recycled to the crossflow membrane feed. The sweep stream has enriched CO2 but slightly depleted O2 is combined with combustion air in the FCC regenerator.

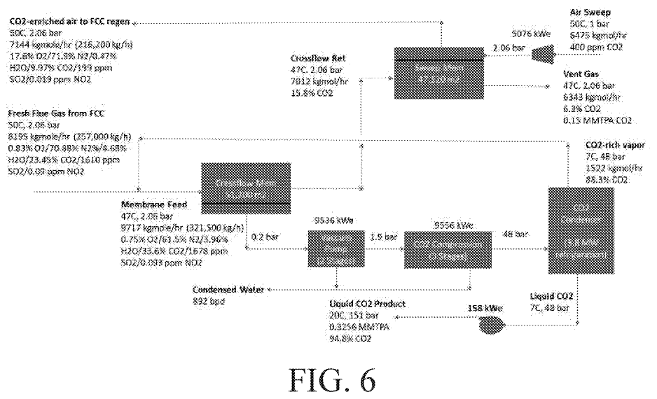

An embodiment of the membrane configuration is elimination of the polishing membrane (FIG. 6). The overhead of the CO2 condenser is recycled back to the feed of the crossflow membrane. Because the crossflow membrane is processing a much higher % CO2 compared to the process in FIGS. 4, the overall CO2 recovery is worse and permeate compression requirements are higher.

Permeance is directly related to the thickness of the membrane and will characterize the gas transport through the membrane. Permeance is an important parameter when comparing the separation suitability of membranes for mixed gases. A practical unit often used is gas permeation unit (GPU). The membranes for the crossflow, air sweep, and polishing steps are all preferably polymeric, hollow-fiber membranes with CO2 permeance of >1000 GPU and CO2/N2 selectivity of 25 to 50 and O2/N2 selectivity of 5 to 10. The polymeric materials may be any known in the art provided they can achieve this separation performance under both wet flue gas conditions and in the high-pressure polishing conditions. For example, the crossflow membrane may have high GPU and selectivity for CO2, while the sweep membrane has high GPU and selectivity for CO2, and low O2/N2 selectivity and the polishing membrane operates at 45 bar and 7 C—low to modest CO2/N2 selectivity but high CO2 permeance and high durability.

The hollow fiber membranes may be selected from those known to one of skill in the art selected from the consisting of polypropylene, polyethylene, polytetrafluoroethylene, polyvinylidene difluoride, polysulfone, PEBAX, PDMS, polyimide, carbon molecular sieve, graphene oxide, mixed matrix—comprising zeolites and or metal organic frameworks and polyetherimide based membranes.

An FCC combustor will have different operating parameters with regard to temperature, pressure and excess O2 when compared to other combustion sources. As such, a preferred embodiment of the invention, seen in FIG. 4, wherein the flue gas from FCC containing CO2 is fed to a crossflow membrane for feed into a sweep membrane or to a vacuum pump with CO2 compression, condensation and feed to a polishing membrane, results in the largest amount of avoided CO2 emissions.

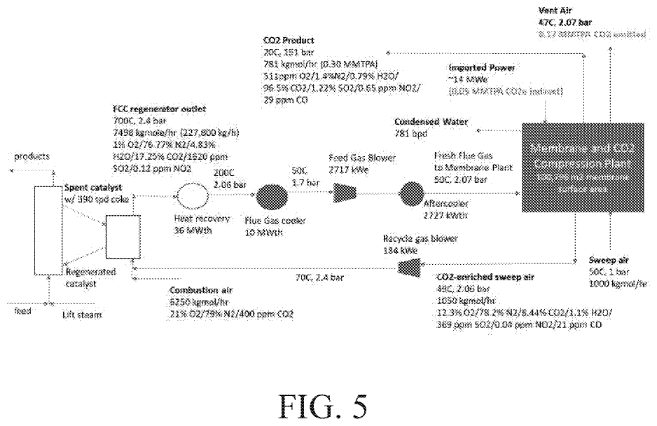

Table 1 summarizes a comparison of the various embodiments. The process with the highest avoided CO2 emissions is FIG. 4, utilizing a high air sweep and polishing membrane. The process with the lowest power requirement is FIG. 5, utilizing a low air sweep and polishing membrane.

TABLE 1

| | | Membrane | Membrane | Membrane |
|---|---|---|---|---|
| | Controlled | Case 1- | Case 2- | Case 3-no |
| | FCC | high sweep | low sweep | polishing |
| Combustion | 6873 | 847 | 6250 | 847 |
| Air (kgmol/hr) | | | | |
| Sweep Air | 0 | 6475 | 1000 | 6475 |
| (kgmol/hr) | | | | |
| Total Air | 6873 | 7322 | 7250 | 7322 |
| (kgmol/hr) to | | | | |
| FCC | | | | |
| CO2 direct | 0.46 | 0.08 | 0.17 | 0.15 |
| emissions | | | | |
| (MMTPA) | | | | |
| CO2 indirect | 0 | 0.08 | 0.05 | 0.11 |
| emissions | | | | |
| (MMTPA) | | | | |
| Total CO2 | 0.46 | 0.16 | 0.22 | 0.26 |
| emissions | | | | |
| (MMTPA) | | | | |
| Power import | 0 | 23 | 14 | 28.5 |
| (MW) | | | | |
| Total | 0 | 100,796 | 100,796 | 98,320 |
| membrane | | | | |
| surface area | | | | |
| (m2) | | | | |
| CO2 liquid | 0 | 0.39 | 0.30 | 0.33 |
| product (>95 | | | | |
| mol % purity, | | | | |
| 151 bar) | | | | |

While the figures and description above describe the processes with respect to an FCC regenerator flue gas from the combustion of coke on a catalyst being regenerated, it should be appreciated that the processes may be applicable to other combustion processes as well. Such combustion processes may comprise amount of CO2 in the generated gas of from about 800 to about 20%.

For example, the combustion may be occurring in a gas fired boiler, a biomass fired boiler, a coal fired boiler, or a steam methane reforming (SMR) hydrogen process. In some embodiments, the combustion may be in a refinery. In a refinery or other higher temperature process it may be desirable to first cool the generated gas prior to treating with membranes as some membranes may not be operable above about 50 C. In such cases, any cooling method such as, for example, direct contact cooling may be employed.

The processes are described above with respect to employing two membranes in series but may be employed in other membrane configurations as well. Employing two membranes in series may be beneficial because a “sweep membrane” may helps with the concentration of CO2 via a recycle and may also provide a combustion source for the combustion in the FCC regenerator or other combustion in a boiler, SMR hydrogen, or refinery. By burning the combustion source with slightly depleted O2 levels compared to fresh air, the CO2 in the flue gas increases in concentration which makes CO2 capture more efficient and economical. Such sweep membranes are typically hollow fiber or cross flow membranes although in some embodiments a spiral wound membrane could at least be considered.

As shown in some figures, the methods herein may employ two stage compression of permeate using vacuum pumps followed by three stages of compression prior to liquefaction. A high pressure polishing membrane of a CO2-rich vapor is then optional. However, it should be understood that the processes are not so limited. That is, the specific manner is not particularly critical so long as CO2 may be be delivered at supercritical pressure (e.g. >110 bar). By having the liquefaction process integrated with membranes it may beneficially provide flexibility in choosing the specific liquefaction pressure to balance refrigeration and CO2 pumping requirements.

As described above and in the figures with respect to the FCC regenerator embodiments, the processes described herein generally include (a) wherein a flowrate of the counter-current air sweep is adjusted to maintain about the same percentage of excess oxygen as an FCC regenerator; or (b) wherein a portion of combustion air for the FCC regenerator is replaced by CO2-enriched, oxygen-depleted air sweep from the membrane operating with counter-current air sweep; or (c) both (a) and (b). The same is true when the processes are employed for other combustion processes.

In regard to (a), by maintaining about the same percentage of excess oxygen as an FCC regenerator or other combustion it is meant to not go much lower in oxygen so as to avoid the risks of incomplete combustion. On the other hand, maintaining about the same percentage of excess oxygen includes allowing for higher excess air and corresponding oxygen such as to dilute the CO2 concentration a bit and provide a higher margin of ensuring complete combustion. Thus, in some embodiments 99-110% of the same percentage of excess oxygen may be employed.

In regard to (b), the processes are efficient in that a portion of combustion air for the FCC regenerator is replaced by CO2-enriched, oxygen-depleted air sweep from the membrane operating with counter-current air sweep. Of course, it should be understood that a portion includes up to about 100% of the air sweep in embodiments wherein one desires to maximize CO2 recovery.

While specific liquefication steps are described above and in the figures, it should be understood that CO2 can be liquefied over a very broad range of temperatures and pressures, with economic tradeoff between compression costs, refrigeration costs, and thickness of vessels. Thus, the pressure may from about 7 bar to about 80 bar depending upon equipment and desired conditions. Of course, at higher pressures such as 60 to 80 bar one may liquefy with, for example, cooling water. In some embodiments, the pressure may be at least about 15, or at least about 40 up to about 60 bar. Of course, if a polishing membrane is employed one may consider the appropriate limits on membrane feed pressure.

### Specific Embodiments

1. A method for capturing CO2 produced from a FCC regenerator flue gas comprising,
treating the flue gas with a crossflow membrane and then treating at least a portion of the crossflow membrane treated flue gas with a second membrane comprising a counter-current air sweep on the permeate side; and
liquefying CO2 in a permeate from the crossflow membrane to produce a liquefied CO2 and a CO2-rich vapor;
(a) wherein a flowrate of the counter-current air sweep is adjusted to maintain about the same percentage of excess oxygen as an FCC regenerator; or
(b) wherein a portion of combustion air for the FCC regenerator is replaced by CO2-enriched, oxygen-depleted air sweep from the membrane operating with counter-current air sweep; or
(c) both (a) and (b).
2. The method of embodiment 1, wherein the counter-current air sweep on the permeate side is operated under conditions sufficient to reduce the CO2 amount.
3. The method of embodiment 1, further comprising polishing the CO2-rich vapor with a high pressure polishing membrane to produce a polishing membrane permeate and a polishing membrane retentate wherein the polishing membrane permeate is liquefied and the polishing membrane retentate is recycled to the crossflow membrane.
4. The method of embodiment 1, wherein the crossflow membrane is a hollow fiber membrane.
5. The method of embodiment 3, wherein the high pressure polishing membrane is a hollow fiber membrane.
6. The method of embodiment 4, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.
7. The method of embodiment 5, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.
8. The method of embodiment 5, wherein the membrane is a facilitated transport membrane or a membrane comprising a hydrophilic polymer.
9. The method of embodiment 1, wherein the crossflow membrane operates at a vacuum permeate pressure up to about 0.2, or up to about 0.3, or up to about 0.4, or up to about 0.5 bar.
10. The method of embodiment 1 which further comprises cooling, compressing, or both of the flue gas prior to treating the flue gas with a crossflow membrane.
11. The method of embodiment 10, wherein the flue gas is cooled to a temperature of less than about 60° C., or less than about 50° C.
12. The method of embodiment 11, wherein the cooling comprises a plurality of stages.
13. The method of embodiment 10, wherein the cooling, compressing, or both is sufficient to overcome pressure drop downstream of FCC regenerator.
14. The method of embodiment 1, wherein the liquefying operates at a temperature and pressure sufficient to produce liquid CO2 with a purity greater than 95%, or greater than 99%.
15. The method of embodiment 1, wherein the liquefying operates at a temperature of from about 5 to about 15° C. and a pressure of from about 40 to 60 bar to produce liquid CO2 with a purity greater than 95%,
16. The method of embodiment 1, wherein the crossflow membrane operates at a feed pressure of from about 1.05 up to about 2, or up to about 3 bar.
17. The method of embodiment 1, wherein the flue gas comprises from about 8% up to about 20%, or up to about 25% CO2 by volume.
18. The method of embodiment 1, wherein the liquefying operates at a temperature and a pressure sufficient to produce liquid CO2 with a purity greater than 95%, or greater than 99%.
19. The method of embodiment 3, wherein the high-pressure polishing membrane operates at a feed pressure sufficient to achieve a CO2 purity in the retentate of at least 95% or more.
20. The method of embodiment 1, wherein the crossflow membrane has a CO2/N2 selectivity of at least about 10, or at least about 25, or at least about 45, up to about 80, or up to about 100, or up to about 150.
21. The method of embodiment 1, wherein the crossflow membrane has a CO2 permeance greater than about 250 GPU.
22. A method for capturing CO2 produced from a generated gas comprising,
   treating the generated gas with a crossflow membrane and then treating at least a portion of the crossflow membrane treated generated gas with a second membrane comprising a counter-current air sweep on the permeate side; and
   liquefying CO2 in a permeate from the crossflow membrane to produce a liquefied CO2 and a CO2-rich vapor;
   wherein an amount of CO2 in the generated gas is from about 8% to about 20% and wherein the generated gas is from a combustion;
   (a) wherein a flowrate of the counter-current air sweep is adjusted to maintain about the same or higher percentage of excess oxygen as that being combusted in the combustion; or
   (b) wherein a portion of combustion air for the combustion is replaced by CO2-enriched, oxygen-depleted air sweep from the membrane operating with counter-current air sweep; or
   (c) both (a) and (b).
23. The method of embodiment 22 wherein the combustion is in a gas fired boiler, a biomass fired boiler, a coal fired boiler, or a steam methane reforming hydrogen process.
24. The method of embodiment 22 wherein the combustion is in a refinery and wherein the method further comprises cooling the generated gas prior to treating.
25. The method of embodiment 22, wherein the counter-current air sweep on the permeate side is operated under conditions sufficient to reduce the CO2 amount.
26. The method of embodiment 22, further comprising polishing the CO2-rich vapor with a high pressure polishing membrane to produce a polishing membrane permeate and a polishing membrane retentate wherein the polishing membrane permeate is liquefied and the polishing membrane retentate is recycled to the crossflow membrane.
27. The method of embodiment 22, wherein the crossflow membrane is a hollow fiber membrane.
28. The method of embodiment 26, wherein the high pressure polishing membrane is a hollow fiber membrane.
29. The method of embodiment 27, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.
30. The method of embodiment 28, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.
31. The method of embodiment 26, wherein the membrane is a facilitated transport membrane or a membrane comprising a hydrophilic polymer.
32. The method of embodiment 22, wherein the crossflow membrane operates at a vacuum permeate pressure up to about 0.2, or up to about 0.3, or up to about 0.4, or up to about 0.5 bar.
33. The method of embodiment 22 which further comprises cooling, compressing, or both of the flue gas prior to treating the flue gas with a crossflow membrane.
34. The method of embodiment 33, wherein the flue gas is cooled to a temperature of less than about 60° C., or less than about 50° C.
35. The method of embodiment 34, wherein the cooling comprises a plurality of stages.
36. The method of embodiment 33, wherein the cooling, compressing, or both is sufficient to overcome pressure drop downstream of FCC regenerator.
37. The method of embodiment 22, wherein the liquefying operates at a temperature and pressure sufficient to produce liquid CO2 with a purity greater than 95%, or greater than 99%.
38. The method of embodiment 22, wherein the liquefying operates at a temperature of from about 5 to about 15° C. and a pressure of from about 40 to 60 bar to produce liquid CO2 with a purity greater than 95%.
39. The method of embodiment 22, wherein the crossflow membrane operates at a feed pressure of from about 1.05 up to about 2, or up to about 3 bar.
40. The method of embodiment 22, wherein the flue gas comprises from about 8% up to about 20%, or up to about 25% CO2 by volume.
41. The method of embodiment 22, wherein the liquefying operates at a temperature and a pressure sufficient to produce liquid CO2 with a purity greater than 95%, or greater than 99%.
42. The method of embodiment 26, wherein the high-pressure polishing membrane operates at a feed pressure sufficient to achieve a CO2 purity in the retentate of at least 95% or more.
43. The method of embodiment 22, wherein the crossflow membrane has a CO2/N2 selectivity of at least about 10, or at least about 25, or at least about 45, up to about 80, or up to about 100, or up to about 150.
44. The method of embodiment 22, wherein the crossflow membrane has a CO2 permeance greater than about 250 GPU.

What is claimed is:

1. A method for capturing CO2 produced from a FCC regenerator flue gas comprising,
treating the flue gas with a crossflow membrane and then treating at least a portion of the crossflow membrane treated flue gas with a second membrane comprising a counter-current air sweep on the permeate side; and
liquefying CO2 in a permeate from the crossflow membrane to produce a liquefied CO2 and a CO2-rich vapor;
(a) wherein a flowrate of the counter-current air sweep is adjusted to maintain about the same percentage of excess oxygen as an FCC regenerator; or
(b) wherein a portion of combustion air for the FCC regenerator is replaced by CO2-enriched, oxygen-depleted air sweep from the membrane operating with counter-current air sweep; or
(c) both (a) and (b).

2. The method of claim 1, wherein the counter-current air sweep on the permeate side is operated under conditions sufficient to reduce the CO2 amount.

3. The method of claim 1, further comprising polishing the CO2-rich vapor with a high pressure polishing membrane to produce a polishing membrane permeate and a polishing membrane retentate wherein the polishing membrane permeate is liquefied and the polishing membrane retentate is recycled to the crossflow membrane.

4. The method of claim 1, wherein the crossflow membrane is a hollow fiber membrane.

5. The method of claim 3, wherein the high pressure polishing membrane is a hollow fiber membrane.

6. The method of claim 4, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.

7. The method of claim 5, wherein the hollow fiber membrane is selected from the group consisting of polypropylene, polyethylene, polytetrafluoroethylene, polyvinylidene difluoride, polysulfone, polyamide-polyether block copolymer, PDMS, polyimide, carbon molecular sieve, graphene oxide, mixed matrix, zeolites, metal organic frameworks and polyetherimide.

8. The method of claim 5, wherein the membrane is a facilitated transport membrane or a membrane comprising a hydrophilic polymer.

9. The method of claim 1, wherein the crossflow membrane operates at a vacuum permeate pressure up to about 0.5 bar.

10. The method of claim 1 which further comprises cooling, compressing, or both of the flue gas prior to treating the flue gas with a crossflow membrane.

11. The method of claim 10, wherein the flue gas is cooled to a temperature of less than about 60° C.

12. The method of claim 11, wherein the cooling comprises a plurality of stages.

13. The method of claim 10, wherein the cooling, compressing, or both is sufficient to overcome pressure drop downstream of FCC regenerator.

14. The method of claim 1, wherein the liquefying operates at a temperature and pressure sufficient to produce liquid CO2 with a purity greater than 95%.

15. The method of claim 1, wherein the liquefying operates at a temperature of from about 5 to about 15° C. and a pressure of from about 40 to 60 bar to produce liquid CO2 with a purity greater than 95%.

16. The method of claim 1, wherein the crossflow membrane operates at a feed pressure of from about 1.05 to about 3 bar.

17. The method of claim 1, wherein the flue gas comprises from about 8% to about 25% CO2 by volume.

18. The method of claim 1, wherein the liquefying operates at a temperature and a pressure sufficient to produce liquid CO2 with a purity greater than 95%.

19. The method of claim 3, wherein the high-pressure polishing membrane operates at a feed pressure sufficient to achieve a CO2 purity in the retentate of at least 95%.

20. The method of claim 1, wherein the crossflow membrane has a CO2/N2 selectivity of 10-150.

21. The method of claim 1, wherein the crossflow membrane has a CO2 permeance greater than 250 GPU.

22. A method for capturing CO2 produced from a generated gas comprising,
treating the generated gas with a crossflow membrane and then treating at least a portion of the crossflow membrane treated generated gas with a second membrane comprising a counter-current air sweep on the permeate side; and
liquefying CO2 in a permeate from the crossflow membrane to produce a liquefied CO2 and a CO2-rich vapor;
wherein an amount of CO2 in the generated gas is from about 8% to about 20% and wherein the generated gas is from a combustion;
(a) wherein a flowrate of the counter-current air sweep is adjusted to maintain about the same or higher percentage of excess oxygen as that being combusted in the combustion; or
(b) wherein a portion of combustion air for the combustion is replaced by CO2-enriched, oxygen-depleted air sweep from the membrane operating with counter-current air sweep; or
(c) both (a) and (b).

23. The method of claim 22 wherein the combustion is in a gas fired boiler, a biomass fired boiler, a coal fired boiler, or a steam methane reforming hydrogen process.

24. The method of claim 22 wherein the combustion is in a refinery and wherein the method further comprises cooling the generated gas prior to treating.
